(19) United States
(12) Patent Application Publication
(10) Pub. No.: US 2006/0204765 A1
(43) Pub. Date: Sep. 14, 2006

(54) Laminated glass with polysiloxane-urea copolymer

(75) Inventors: Uwe Scheim, Coswig (DE); Oliver Schäfer, Burghausen (DE); Ernst Selbertinger, Nünchritz (DE)

Correspondence Address: BROOKS KUSHMAN P.C., 1000 TOWN CENTER, TWENTY-SECOND FLOOR, SOUTHFIELD, MI, 48075, US

(73) Assignee: Wacker-Chemie GmbH, Munchen (DE)

(21) Appl. No.: 10/551,610

(22) PCT Filed: Apr. 1, 2004
(86) PCT No.: PCT/EP04/03451

§ 371 Date: Sep. 30, 2005

(30) Foreign Application Priority Data
Apr. 10, 2003 (DE) 103 16 521.5

(51) Int. Cl. B32B 17/06

(52) U.S. Cl. 428/429; 427/356

(57) ABSTRACT

A laminated glass comprises: A) at least one layer consisting of inorganic or organic glass and B) at least one layer consisting of a polysiloxane-urea copolymer which is obtained by reacting a mixture of linear polysiloxanes of general formula Q-T-SiR₂O—(SiR₂O)ₙ—SiR₂-T-Q and branched polysiloxanes of general formula (Q-T-SiR2O_{1/2})ₐ(Q-T-SiRO_{2/2})_{b}(Q-T-SiO_{3/2})_{c}(R₃SiO_{2/2})_{d}(R₂SiO_{2/2})_{c}(RSiO_{3/2})_{f}(SiO_{4/2})_{g} with polyfunctional isocyanates. The laminates exhibit excellent moisture resistance.

The invention relates to laminated glass comprising at least one layer of inorganic or organic glass and at least one layer of polysiloxane-urea copolymer and the production thereof.

Laminated glass has long been in use. It has a sandwich-like structure and has at least one glass sheet and a polymeric layer present thereon. Laminated glass has various advantages over standard glass. In the case of a break due to the action of force, the polymeric layer binds the splinters so that the danger of injury is substantially less than in the case of standard glass. The advantage over toughened glass is that the laminated glass pane is still transparent after a break. Laminated glass also complicates the penetration of the pane construction by the action of force, such as breaking in with tools, projectiles or objects flying around in the case of whirlwinds, such as, for example, large wood splinters. Moreover, additional sound and heat insulation can be achieved by the multilayer design. The field of use of laminated glass includes automotive and vehicle construction, aircraft construction and the building industry.

The intermediate polymeric layers must have a combination of properties, such as, for example, little or no opacity, high strength, very good UV stability, very good adhesion to glass and low moisture absorption in combination with very good moisture resistance.

Most frequently, plasticized polyvinyl butyral (PVB) in film form is used as the intermediate polymeric layer. This technology has been successfully used for over 70 years and has been constantly further developed and refined both with respect to the polymer films and with respect to the processing technologies.

The polyvinyl butyral, consisting of actual PVB resin itself having a relatively high content of free OH groups and a plasticizer, is used as a rule as 0.76 mm thick film, which is bonded to the glass panes by heating and pressing in vacuo. The PVB is very sensitive to changes in temperature and in relative humidity. In order to prevent the PVB films from sticking to one another, for example the rolls of film must be stored at low temperatures prior to use. This moisture sensitivity may lead to increased opacity in the polymer films and ultimately also to bubble formation in the laminated glasses. This effect occurs in particular at the edges of the laminated glasses. During the production of the laminated glasses, these effects can be avoided by appropriate acclimatization and conditioning of the PVB films, but these effects can nevertheless be caused, for example, by moisture entering at the edges in the course of time during the use of the laminated glasses. This phenomenon of delamination by penetration of moisture and chemicals has already been found before the introduction of PVB as intermediate polymeric layer, and attempts were made to eliminate the problem by an improved design. The problem is also eliminated at least optically merely by applying coatings to the edge zones. Although this avoids esthetic impairment, the actual problem of delamination is not eliminated. A further disadvantage of the PVB films is the plasticizer content thereof. This plasticizer may be exuded in the course of time, which may lead to a change in the mechanical properties of the PVB film, i.e. the film becomes brittle and fragile. The laminated glass loses its safety effect in these places. Moreover, the exudation of plasticizer may likewise lead to delamination phenomena, beginning at the edges of the laminated glass.

The edges of the laminated glasses produced using PVB films are moreover sensitive to chemicals which may be exuded, for example, from sealing compounds. However, sealing compounds are frequently necessary for permanently binding the laminated glass to a frame construction. Delamination may once again occur.

A very serious disadvantage of the laminated glasses comprising PVB film results from the relatively high glass transition temperature T_{g} of the PVB, which is about 16° C. in the case of the plasticizer-containing types. At a temperature substantially below or substantially above the glass transition temperature, the laminated glass may lose its good safety properties.

Alternative proposals for the intermediate polymeric layer, namely polyurethanes, polyureas, epoxides, polyesters, (meth)acrylates, silicones, silicone resin polymers, MS polymers (modified silicone polymers), hotmelt adhesives, coatings and sealing compounds, plastisols, polyethylenes and polyvinyl acetate, are described, for example in WO 99/62707.

DE 1596960 describes laminated safety glass articles in which the intermediate layer consists of a silicon-containing polyurethane. These silicon-containing polyurethanes contain reaction products of polyols with silicone compounds which contain silanol or alkoxysilane groups. This results in the formation of compounds which contain Si—O—C linkages which are known to be unstable to hydrolysis. In the course of use, laminated glasses comprising such a polymer would therefore lose their properties from the edges, since a gradual destruction of the polymers occurs. The laminated glass therefore ceases to function in these zones. The polyurethanes of DE 1596960 may also contain silicon-containing compounds having Si—CH₂—OH groups. Such compounds are, however, obtainable only with very great difficulty and are therefore expensive to produce. Furthermore, it is mentioned that amino groups can be introduced via aminoalcohols, which, however, leads to products which are likewise unstable to hydrolysis and moreover also tend to become discolored.

U.S. Pat. No. 6,156,417 describes polyurethanes which can also be modified by siloxanes. In addition to simple admixing of siloxanes, it is stated that the products can be obtained by reacting siloxanols with isocyanates, resulting in silylurethanes, which are likewise unstable to hydrolysis.

In addition, the mechanical properties which can be achieved with siloxane-containing polyurethanes are not sufficient for the intended use in laminated glass. This situation does not change even if the functional groups are bonded to the silicone backbone via Si—C bonds.

The invention relates to a laminated glass which comprises
(A) at least one layer of inorganic or organic glass and
(B) at least one layer of a polysiloxane-urea copolymer which is obtainable by reacting a mixture of
a1) linear polysiloxanes of the general formula (1)
   Q-T-SiR₂O—(SiR₂O)ₙ—SiR₂-T-Q (1)
and
a2) branched polysiloxanes of the general formula (2)
   (Q-T-SiR₂O_{1/2})ₐ(Q-T-SiRO_{2/2})_{b}(Q-T-SiO_{3/2})_{c}(R₃SiO_{1/2})_{d}(R₂SiO_{2/2})ₑ(RSiO_{3/2})_{f}(SiO_{4/2})_{g} (2)
   in which
Q is NH—R¹ or OH,
T is a divalent hydrocarbon radical having 1 to 20 carbon atoms, in which non-neighboring methylene units may be replaced by NR⁶ or O groups and
R is a monovalent, optionally fluorine-, chlorine- or —CN-substituted hydrocarbon radical having 1 to 20 carbon atoms,
R¹ is a hydrogen or a monovalent, optionally fluorine-, chlorine- or —CN-substituted hydrocarbon radical having 1 to 20 carbon atoms,
R⁶ is a hydrogen atom or a monovalent, optionally fluorine- or chlorine- or —CN-substituted hydrocarbon radical having 1 to 6 carbon atoms,
n has the value 0 or integral values from 1 to 1000 and
a, b, c, d, e, f, and g have the value 0 or integral values,
   with the proviso that the sum of b+c+f+g is at least 1, that the sum of a+b+c is at least 2 and, for Q, the ratio of the meanings NH—R¹:OH is chosen so that the ratio of the urea groups and urethane groups in the polysiloxane-urea copolymer (B) is at least 4:1, with
   b) polyfunctional isocyanates.

The polysiloxane-urea copolymers (B) which are obtainable by reacting mixtures of linear amino-functional polysiloxanes (a1) and branched aminofunctional polysiloxanes (a2) with polyfunctional isocyanates (b) having at least two NCO groups subsequently achieve appropriate strengths, as achieved by the PVB films, when the ratio of urea groups to urethane groups is at least 4:1.

By combining the linear aminofunctional polysiloxanes (a1) and branched aminofunctional polysiloxanes (a2) with the polyfunctional isocyanates (b), it is possible to combine all desired properties such as high strength of the polymers (B) with sufficient resilience and low glass transition temperature T_{g}, the properties changing only slightly over a wide temperature range. Moreover, the polymers (B) thus prepared do not tend to become discolored.

Preferably, T is a divalent straight-chain or branched alkyl, aryl or aralkyl radical, which is preferably straight-chain. Preferably, T has a hydrocarbon radical having 1 to 6 carbon atoms. In particular T is methylene or propylene.

The hydrocarbon radicals R, R¹ may be linear, branched or cyclic aliphatic, aromatic or mixed aliphatic-aromatic. Preferably, R and R¹ are a monovalent alkyl radical having 1 to 6 carbon atoms and the phenyl radical; in particular, they are unsubstituted. Particularly preferred radicals R and R¹ are methyl, ethyl, vinyl and phenyl, in particular methyl.

R⁶ is preferably a hydrogen atom or a methyl, ethyl, propyl or butyl radical.

n preferably has values from 10 to 200; values from 10 to 50 are particularly preferred.

The linear polysiloxane (a1) of the general formula (1) is substantially linear. This means that T units (RSiO_{3/2}) are not completely ruled out but should be present only within the range of the impurities resulting from the technology. Preferably, not more than 5 T units, in particular not more than 1 T unit, are present per 1000 D units (SiR₂O).

In the branched polysiloxane (a2) of the general formula (2), the sum of a+b+c is preferably from 3 to 40, in particular from 3 to 10, and the sum of d+e+f+g is preferably from 0 to 160, in particular from 0 to 40.

In the branched polysiloxane (a2), the sum of a+b+c+d+e+f+g preferably has values from 3 to 200; values from 3 to 50 are particularly preferred.

Aminofunctional polysiloxanes (a2) in which b=c=e=f=0 (QMM^{A} resin) or a=c=f=g=0 (amine oil having amino side groups) are preferred.

The weight ratio of linear aminofunctional polysiloxanes (a1) to branched aminofunctional polysiloxanes (a2) is preferably from 50:50 to 95:5, in particular from 65:35 to 90:10.

The ratio of the urea groups and urethane groups in the polysiloxane-urea copolymer (B) is at least 10:1, particularly preferably 50:1; in particular, only urea groups are present.

The polyfunctional isocyanates (b) have at least 2 and preferably not more than 4 isocyanate groups. Organic diisocyanates and prepolymers are preferred, in particular linear prepolymers having in each case 2 isocyanate groups and mixtures thereof.

Preference is given to diisocyanates or prepolymers of the general formula (3)
OCN—B—[NH—C(O)—X-A-X—C(O)—NH—B—]ₘNCO (3)
in which
A is a divalent, optionally fluorine-, chlorine- or —CN-substituted hydrocarbon radical having 1 to 5000 carbon atoms, which may be interrupted by groups which are selected from —O— and —O—CO—O—,
B is a divalent optionally fluorine-, chlorine- or —CN-substituted hydrocarbon radical having 1 to 100 carbon atoms
X is N—R¹ or O and
m has the value 0 or from 1 to 10,
   with the proviso that, if m>0, for X the ratio of the meanings N—R¹:O is chosen so that the ratio of the urea groups and urethane groups in the polysiloxane-urea copolymer (B) is at least 4:1.

Particularly preferably, m is 0.

Preferred polyfunctional isocyanates are diisocyanates, such as, for example, 4,4′-methylenebis(phenylisocyanate)MDI, 2,4- and 2,6-toluene diisocyanate TDI, hexamethylene diisocyanate HMDI and isophorone diisocyanate IPDI. Aliphatic isocyanates are particularly preferred.

The prepolymers are prepared by reacting the abovementioned isocyanates with less than the stoichiometric amount of polyols. Preferred polyether components for the prepolymers are polyethylene glycols, polypropylene glycols, polyethylene propylene glycols and polyester polyols.

For improving the adhesion, adhesion-promoting silanes may be added to the polysiloxane urea copolymers (B). Examples of adhesion promoters are silanes having hydrolyzable groups and SiC-bound vinyl, acryloyloxy, methacryloyloxy, isocyanato, epoxy, acid anhydride, acid, ester or ether groups and partial and mixed hydrolysis products thereof.

Examples of adhesion promoters are 3-isocyanatopropyltrimethoxysilane, 3-isocyanatopropyltriethoxysilane, 3-isocyanatopropyldimethoxymethylsilane, 3-isocyanatopropyldiethoxymethylsilane, 3-isocyanatopropylmethoxydimethylsilane, 3-isocyanatopropylethoxydimethylsilane, isocyanatomethyltrimethoxysilane, isocyanatomethyltriethoxysilane, isocyanatomethyldimethoxymethylsilane, isocyanatomethyldiethoxymethylsilane, isocyanatomethylmethoxydimethylsilane and isocyanatomethylethoxydimethylsilane, 3-aminopropyltrimethoxysilane, 3-aminopropyltriethoxysilane, 3-(2-aminoethyl)aminopropyltrimethoxysilane, 3-(2-aminoethyl)aminopropyltriethoxysilane, 3-aminopropylmethyldimethoxysilane, 3-(2-aminoethyl)aminopropylmethyldimethoxysilane, cyclohexylaminomethyltriethoxysilane, glycidoxypropyltrimethoxysilane and glycidoxypropyltriethoxysilane.

Silanes having vinyl groups and silanes having epoxy groups which contain ethoxy or acetoxy groups as hydrolyzable radicals are preferred. Glycidyloxypropyltriethoxysilane, vinyltriethoxysilane and vinyltriacetoxysilane or the partial or mixed hydrolysis products thereof are particularly preferred.

The adhesion promoters are added in amounts of from 0.01% to 5%, preferably from 0.1% to 2%, particularly preferably from 0.4% to 0.7%, based in each case on the total mass of copolymer (B).

The adhesion-promoting silanes or the solutions and hydrolysis condensation products thereof can also be applied to the surface of the film produced from polysiloxane-urea copolymers (B).

In a preferred process for the production of the laminated glass, the polysiloxane-urea copolymer (B) is prepared in a first step by reacting a mixture of linear polysiloxanes (a1) and branched polysiloxanes (a2) and polyisocyanates (b), and the polysiloxane-urea copolymer (B) is applied in a second step to at least one layer of inorganic or organic glass (A).

The preparation of the polysiloxane-urea copolymer (B) can be effected either in a suitable solvent or in the absence of a solvent. Adhesion-promoting silanes can be added in the first step or during the reaction.

The polysiloxane copolymers (B) have thermoplastic and resilient properties, i.e. they are elastomeric below the melting point or softening temperature and they are viscous liquids above this temperature.

The reaction of the various components can be effected either in a suitable solvent or in the absence of a solvent in an extruder. Reaction in an extruder is preferred, the individual components being added in succession in a suitable sequence, optionally in each case after a residence time to be determined by the person skilled in the art. At the end of the extruder, the prepared product can be taken off, for example, as granules, or directly as film having the desired thickness. The latter is particularly preferred.

The laminated glass has a sandwich-like structure and consists of at least one glass layer (A) and a layer of polysiloxane copolymer (B) present thereon, but as a rule of at least two glass layers (A) and an intermediate layer (B) which bonds the glass layers (A) to one another. The glass layers (A) may consist either of inorganic glasses, such as, for example, float glass, and/or of organic glasses, such as polycarbonate (PC) or polymethylmethacrylate (PMMA) glass. A glass layer (A) is always followed by a layer of polysiloxane copolymer (B). The layer of polysiloxane copolymer (B) may consist of a uniform material or may itself have a multilayer structure comprising various layers of polysiloxane copolymer (B).

The bond between glass (A) and polysiloxane copolymer (B) can be obtained in various ways. A simple method is, for example, the layer of polysiloxane copolymer (B) as a film. This film is placed between the two glass sheets (A) and the bond is produced by heating to at least a temperature at which this film begins to soften with simultaneous pressing.

A further possibility for the production of the laminated glass comprises applying liquefied polysiloxane copolymer (B) to one of the glass panes (A) by, for example, knife coating, roll coating or screen printing. The laminated glass is then finally obtained by placing the second glass sheet (A) on the layer of polysiloxane copolymer (B), and the bond is once again obtained by increasing the temperature and pressing. Here too, a pretreatment of the glass panes (A) as already described may be effected.

A third possibility comprises combining the two glass sheets (A), optionally once again treated with adhesion promoter, by means of suitable spacers so that a gap of defined width is obtained. Liquefied polysiloxane copolymer (B) is now introduced into this gap from a suitable heated storage vessel by a metering means, the edges of the glass sheet being closed so that the polymer melt does not emerge at undesired points and only the air present between the glass sheets can escape.

For the production of the laminated glass, the polysiloxane-urea copolymer (B) is preferably used as a film.

Preferably, adhesion-promoting silanes are applied to the polysiloxane-urea copolymer (B) or the inorganic or organic glass (A) or both to the polysiloxane-urea copolymer (B) and the inorganic or organic glass (A) after the first step.

The application of the adhesion-promoting silane can be effected in a known manner before the production of the bond to the film and/or the glasses. A solution of adhesion promoters in a suitable solvent may be used. The term priming has become established for this method.

1-8. (canceled)

9. A laminated glass, comprising:
(A) at least one layer of inorganic or organic glass and
(B) at least one layer of one or more polysiloxane-urea copolymer(s) prepared by reacting a mixture of
a1) linear polysiloxanes of the formula (1)
Q-T-SiR₂O—(SiR₂O)ₙ—SiR₂-T-Q (1)
and
a2) branched polysiloxanes of the formula (2)
(Q-T-SiR₂O_{1/2})ₐ(Q-T-SiRO_{2/2})_{b}(Q-T-SiO_{3/2})_{c}(R₃SiO_{1/2})_{d}(R₂SiO_{2/2})ₑ(RSiO_{3/2})_{f}(SiO_{4/2})_{g} (2)
in which
Q is NH—R¹ or OH,
T is a divalent hydrocarbon radical having 1 to 20 carbon atoms, in which non-neighboring methylene units may be replaced by NR⁶ or O groups,
R is a monovalent, optionally fluorine-, chlorine- or —CN-substituted hydrocarbon radical having 1 to 20 carbon atoms,
R¹ is hydrogen or a monovalent, optionally fluorine-, chlorine- or —CN-substituted hydrocarbon radical having 1 to 20 carbon atoms,
R⁶ is hydrogen or a monovalent, optionally fluorine- or chlorine- or —CN-substituted hydrocarbon radical having 1 to 6 carbon atoms,
n has the value 0 or integral values from 1 to 1000 and
a, b, c, d, e, f, and g have the value 0 or integral values,
with the proviso that the sum of b+c+f+g is at least 1, that the sum of a+b+c is at least 2 and, for Q, the ratio of NH—R¹:OH is selected such that the ratio of the urea groups to urethane groups in the polysiloxane-urea copolymer is at least 4:1, with
b) polyfunctional isocyanates.

10. The laminated glass of claim 9, wherein T is a hydrocarbon radical having 1 to 6 carbon atoms.

11. The laminated glass of claim 9, wherein R is a monovalent alkyl radical having 1 to 6 carbon atoms or a phenyl radical.

12. The laminated glass of claim 9, wherein the polysiloxane-urea copolymer contains adhesion-promoting silanes.

13. A process for the production of the laminated glass of claim 9, comprising preparing a polysiloxane-urea copolymer in a first step by reacting a mixture of linear polysiloxanes (a1) and branched polysiloxanes (a2) and polyisocyanates (b), and applying the polysiloxane-urea copolymer in a second step to at least one layer of inorganic or organic glass.

14. The process of claim 13, wherein adhesion-promoting silanes are added in the first step to the polysiloxane-urea copolymer.

15. The process of claim 13, in which adhesion-promoting silanes are applied to the polysiloxane-urea copolymer or the inorganic or organic glass or to both to the polysiloxane-urea copolymer and the inorganic or organic glass after the first step.

16. The process of claim 13, wherein the reaction in the first step is effected in an extruder, and the polysiloxane-urea copolymer formed is then extruded directly as a film.
